(19) United States
(12) Patent Application Publication
(10) Pub. No.: US 2016/0292740 A1
(43) Pub. Date: Oct. 6, 2016

(54) Automatic Notification with Pushed Directions to a Mobile-Device Real-Estate App that Senses a Nearby Chirping Beacon Mounted on a Property-for-Sale Sign

(71) Applicant: OneChirp Corp., SanJose, CA (US)

(72) Inventors: Koroush Akhavan-Saraf, San Jose, CA (US); Ahmad Rafii, Los Gatos, CA (US); Aiden Amir Rafii, Los Gatos, CA (US)

(21) Appl. No.: 14/674,020

(22) Filed: Mar. 31, 2015

(51) Int. Cl. G06Q 30/02; H04W 4/00; H04B 5/00; G06Q 50/16

(52) U.S. Cl. CPC G06Q 30/0261; G06Q 30/0267; G06Q 50/16; H04W 4/008; H04B 5/0031

(57) ABSTRACT

Automatic notification of real estate for sale is provided to a prospective buyer running a real estate app on a mobile device. A chirp beacon that is a Bluetooth Low-Energy (BLE) tag or iBeacon is attached to a real estate sign. The chirp beacon periodically broadcasts its identifier that is received by mobile devices within a range of 10-100 meters. The real estate app sends the identifier to a remote database to find a property IDs. The property ID is looked up in a merged database to obtain property information and directions that are displayed on the mobile device. Additional signs such as at busy intersections or inside the property may also have chirp beacons that cause the real estate app to fetch more information. When real estate app detects a nearby chirp beacon, an audible chirp sound is generated by mobile device. Selling agents receive valuable usage statistics.

### RELATED APPLICATION

This application claims the benefit of the co-pending provisional application for “Automatic notification of property and information by chirping”, U.S. Ser. No. 62/111,678, filed Feb. 4, 2015.

### FIELD OF THE INVENTION

This invention relates to proximity automatic notification systems, and more particularly to automatic notification of real estate sales information to a portable electronic device.

### BACKGROUND OF THE INVENTION

The real estate industry is concerned primarily with the business of buying, selling, or renting of land, buildings, or housing, and includes commercial, industrial as well as residential segments. Real-estate selling agents have traditionally installed signs in front of a property for sale. More recently, flyers describing the property have been printed and placed inside a plastic box that may be mounted to the for-sale sign. Prospective buyers that are driving by a property for sale can take one of these flyers, even when the selling agent is not present at the property. The real-estate agent is not able to monitor who has taken the flyers and when.

Oftentimes the supply of flyers becomes depleted before the selling agent can return to resupply the flyers. The prospective buyer may move on to another property, potentially resulting in a lost sale. Buyers are perhaps more likely to buy a property that has available flyers. Another problem is that flyers that are taken are often misplaced by prospects or lost, and buyers can benefit from a way to organize their options.

When conducting an open house, the agent may place additional signs at major street corners to direct prospective buyers to the property. However, many open houses may occur on a busy weekend, and a large number of signs may be placed at some intersections. This may confuse prospective buyers and result in lower offering prices due to the high perceived supply. Also, the prospective buyer may become confused by the many similar signs when driving to the property and may not reach the intended property.

Prospective buyers may use existing real estate web sites such as Zillow or Trulia to locate a target property to visit. However, when driving around the neighborhood, buyers often spontaneously view and ultimately buy other nearby properties, resulting in a lost sale for the target property.

Real estate signs provide no feedback to the selling agent when a prospective buyer views a sign. The real estate agent does not obtain the contact information of prospective buyers who merely view the signs or retrieve a flyer.

Radio-Frequency Identification (RFID) tags have been used for a variety of applications, and may be added to signs for advertising. Traditional passive RFID tags have no power source or battery. Their power is derived from an external source such as by inductive coupling of RF signals. The distance between the RFID tag and reader (range) is limited to about 3 meters. When a power source is provided to the RFID tag, the range is increased, but so is the cost and size. Near-Field Communication (NFC) devices purposely limit the range to 20 cm for enhanced security. Users need to almost touch their NFC-enabled device such a smartphone to a NFC reader to verify a NFC transaction.

More recently, Bluetooth Low-Energy (BLE) tags have been developed, along with the Bluetooth 4.0 protocol. Unlike passive RFID tags, BLE tags are powered by a low-energy source. Apple has further enhanced BLE tags to create iBeacons. iBeacons are powered by a low energy source such as a battery and thus have enough energy to periodically or continuously broadcast a packet to nearby devices. The range is up to 100 meters, but can be reduced by lowering the broadcast power. The broadcast packets are pushed from the iBeacon/BLE tag to nearby devices while data is pulled from passive RFID tags when energized by a RFID reader. The push broadcast of packets from iBeacons is ideally suited to advertising.

What is desired is a system to push an electronic flyer to a prospective buyer who views a real estate sign. A system to interact with the prospective buyer when the prospect first views a real estate sign is desirable, especially to guide and direct the prospect to the target property to prevent the prospect from being diverted to another property. Feedback to a selling agent is also desired when a prospective buyer retrieves an electronic flyer or views a real estate sign.

### BRIEF DESCRIPTION OF THE DRAWINGS

FIG. 1 highlights a real estate notification system using a mobile application and a notification beacon mounted to a real estate sign.

FIG. 2 shows a prospective buyer obtaining driving directions when passing a remote sign with a chirp beacon.

FIGS. 3A-B show a chirp beacon and its broadcast.

FIG. 4 shows a real estate app running on a mobile device receiving broadcasts from chirp beacons on real estate signs.

FIG. 5 is a more detailed block diagram of a mobile device running a real estate app that receives broadcasts from chirp beacons.

FIGS. 6A-B show backend servers looking up a UUID and providing property details.

FIG. 7 is a flow diagram showing messaging between a real estate app on a mobile device and backend servers when a UUID is obtained from a chirp beacon.

FIG. 8 shows a selling agent configuring a chirp beacon.

FIG. 9 is a flow diagram showing messaging when a selling agent links a chirp beacon to a property.

FIG. 10A-C show merging data from external sources for retrieval by a real estate app.

FIG. 11 shows the real estate app as a plug-in app to a larger real estate application on a mobile device.

FIG. 12 shows property details being displayed and notes taken on a mobile device using menus on a real estate app.

FIG. 13 shows menu items displayed on a web browser for a selling agent user.

### DETAILED DESCRIPTION

The present invention relates to an improvement in real estate notification systems. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

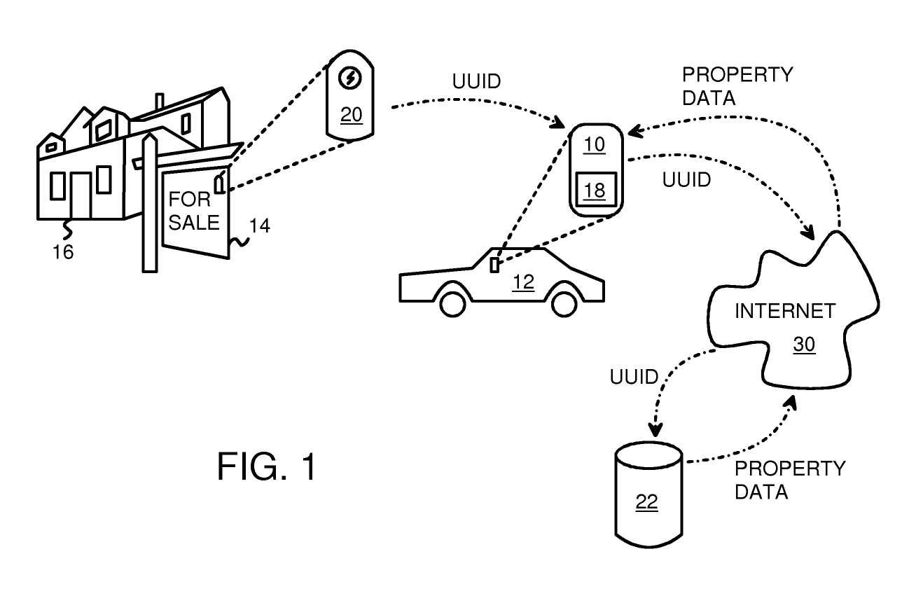

FIG. 1 highlights a real estate notification system using a mobile application and a notification beacon mounted to a real estate sign. Sign 14 is a real estate for sale sign that advertises property 16. Sign 14 is typically placed in the front yard of a home for sale near the street. Chirp beacon 20 is mounted to sign 14.

Chirp beacon 20 is a small electronic beacon that periodically broadcasts a unique identifier (UUID) to nearby receivers, such as to those within 10-100 meters. When prospective buyer 12 drives by property 16 with sign 14, real estate app 18 running on prospective buyer 12's mobile device 10 receives the UUID from chirp beacon 20.

The limited range of chirp beacon 20 typically requires that prospective buyer 12 drive on the same street as property 16. Prospective buyer 12 typically is able to see property 16 when in range of chirp beacon 20. Mobile device 10 may make an audible noise such as a chirp when within range of chirp beacon 20 to notify prospective buyer 12 that property 16 is nearby.

Once real estate app 18 receives the UUID from chirp beacon 20, real estate app 18 sends the UUID over Internet 30 to a UUID database 22. UUID database 22 searches for a matching UUID and provides property data for property 16 with chirp beacon 20 with the matching UUID. This property data is sent back over Internet 30 to real estate app 18 and can be displayed to prospective buyer 12 on mobile device 10. This property data may be formatted as an electronic flyer, or may be viewed within real estate app 18 or another app on mobile device 10.

Prospective buyer 12 does not need to exit the car to view the property data or e-flyer for property 16. This may be advantageous especially during inclement weather. The selling agent does not have to worry about depleting the stock of physical flyers since prospective buyer 12 obtained an electronic flyer using real estate app 18. The selling agent may be notified immediately or at a later time that prospective buyer 12 is within range of chirp beacon 20. This may allow the selling agent to greet prospective buyer 12 at the door when an open house is being held.

Statistics may be complied for use by the selling agent, such as the times and dates that prospective buyers drove by, or the amount of time that each prospective buyer was within range of chirp beacon 20. The selling agent might concentrate on prospective buyers that spent more time within range of chirp beacon 20 since they are likely more interested in property 16.

As long as prospective buyer 12 has real estate app 18 running on mobile device 10, prospective buyer 12 is automatically notified of nearby chirp beacon 20 once prospective buyer 12 is within range of sign 14 and chirp beacon 20. The range is 10-100 meters since chirp beacon 20 is battery powered and periodically broadcasts its UUID, such as once every second or 10 times a second. Thus automatic notification of prospective buyer 12 is achieved.

When prospective buyer 12 does not have real estate app 18 running on mobile device 10, prospective buyer 12 is not notified, but depending on the operating system of their mobile device, prospective buyer 12 can be notified that a compatible real estate app 18 exists that allows them to download the flyer electronically. Thus mobile phone users that are not interested in buying a home are not annoyed by notification or advertising on their mobile device 10, despite the periodic broadcasting of chirp beacon 20.

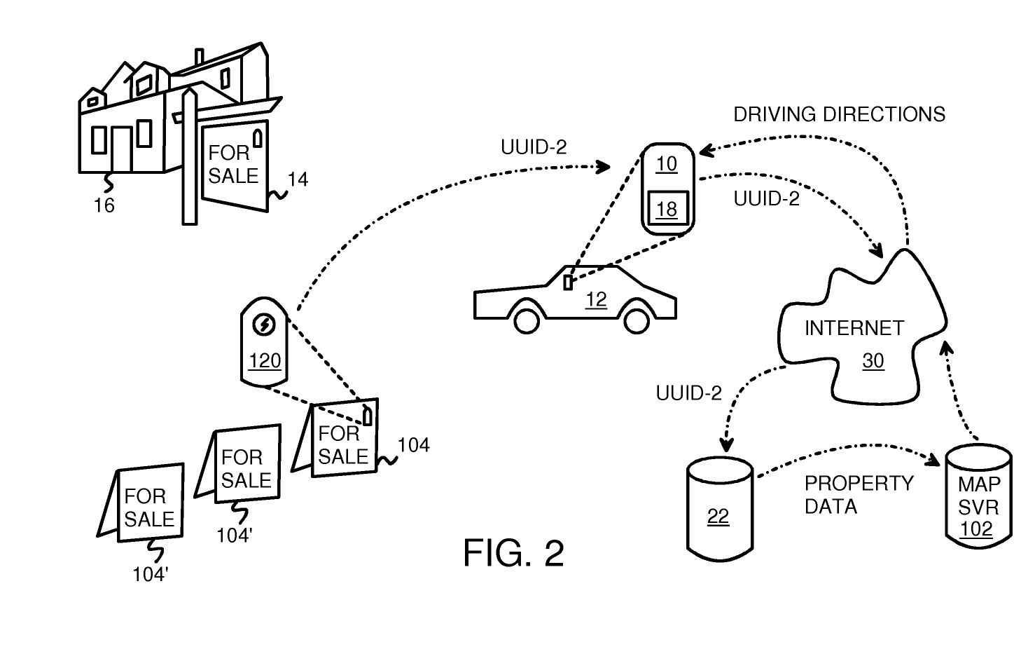

FIG. 2 shows a prospective buyer obtaining driving directions when passing a remote sign with a chirp beacon. Earlier, prospective buyer 12 drove by a major intersection that had many real estate signs 104′, 104. However, only sign 104 had chirp beacon 120 mounted on it; signs 104′ had no chirp beacon.

Chirp beacon 120 periodically broadcasts its identifier, UUID-2, and when prospective buyer 12 drives within range of chirp beacon 120, its UUID-2 is received by real estate app 18 and forwarded over Internet 30 to UUID database 22. The property data being advertised by sign 104 is fetched and sent to map server 102 to obtain driving directions to property 16 from the location of sign 104. These driving directions are displayed on mobile device 10, allowing prospective buyer 12 to drive to property 16. The property data may also be displayed on real estate app 18 to allow prospective buyer 12 to decide whether or not to drive to property 16.

The driving directions may be interactive, such as my using a standard mapping app on mobile device 10, so that prospective buyer 12 is guided step-by-step to property 16. Once prospective buyer 12 arrives at property 16, chirp beacon 20 sends its UUID to mobile device 10, as shown in FIG. 1. Thus prospective buyer 12 may be guided to property 16 and not be diverted by other signs 104′ at the major intersection. The selling agent may be notified immediately of prospective buyer 12 being near sign 104, and may receive statistics such as how many prospective buyers viewed sign 104 and received UUID-2 but did not drive to property 16.

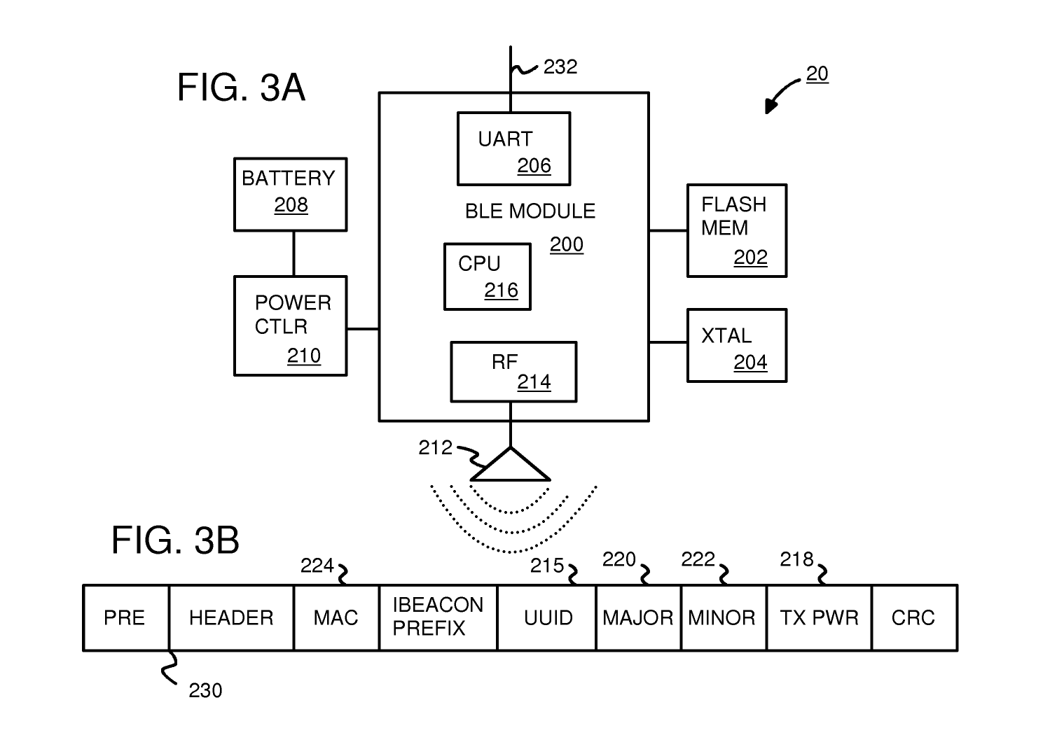

FIGS. 3A-B show a chirp beacon and its broadcast. In FIG. 3A, chirp beacon 20 has Bluetooth Low-Energy (BLE) module 200, which is clocked by crystal 204 and powered by battery 208 through power controller 210. Programs or routines in flash memory 202 or in an embedded memory are executed by central processing unit (CPU) 216. These routines may be updated and parameters such as its UUID and major and minor addresses fields (values) programmed by an external host over serial bus 232 to Universal Asynchronous Receiver Transmitter (UART) 206. The broadcast power may be configured by a host through UART 206 so that a chirp beacon 20 used inside home could have a reduced power and range of just one room, while a chirp beacon 20 used for a busy intersection could have maximum power and range. Once BLE module 200 is programmed, the external host may be disconnected. BLE module 200 may also allow for some programming or configuration to be performed through RF transmitter 214 rather than through UART 206.

BLE module 200 operates using the Bluetooth 4.0 protocol, and is configured to allow chirp beacon 20 to operate as an iBeacon with an Apple OS smart phone or other mobile device as a receiver of a push broadcast packet from chirp beacon 20. Android or other mobile devices that support BLE may also receive the packets broadcast from chirp beacon 20 and provide a similar experience as an app loaded on an Apple device.

However, rather than broadcast advertising or other information for display to a user, chirp beacon 20 broadcasts an identifier, its UUID, without any sales data. The UUID is used to look up a pointer to the advertising information displayed to the user. Sending only the UUID without advertising or related data in the broadcast packet transmitted by chirp beacon 20 reduces the size of the broadcast packet. The smaller broadcast packet allows chirp beacon 20 to be kept small in size, reducing power consumption. A small coin-size battery may be sufficient to power chirp beacon 20 for several months of continuous use.

The UUID is periodically transmitted (pushed) by RF transmitter 214 over antenna 212. FIG. 3B shows a transmission from chirp beacon 20. Packet 230 has a prefix or start field, followed by a header, a Media-Access-Controller (MAC) address 224 for chirp beacon 20, an iBeacon prefix, UUID 215, major address 220, minor address 222, transmit power 218, and a cyclical-redundancy-check (CRC). Transmit power 218 may be useful for determining a range between mobile device 10 and chirp beacon 20. Major address 220 and minor address 222 allow one UUID to be shared for several chirp beacons 20. For example, chirp beacon 20 and chirp beacon 120 may have the same UUID but different major and minor addresses when chirp beacon 20 and chirp beacon 120 are for the same property 16. The UUID, together with the major and minor values may be combined to uniquely designate the beacon, such as UUID-1, UUID-2, and UUID-3 for three beacons with the same base UUID but different major and minor values.

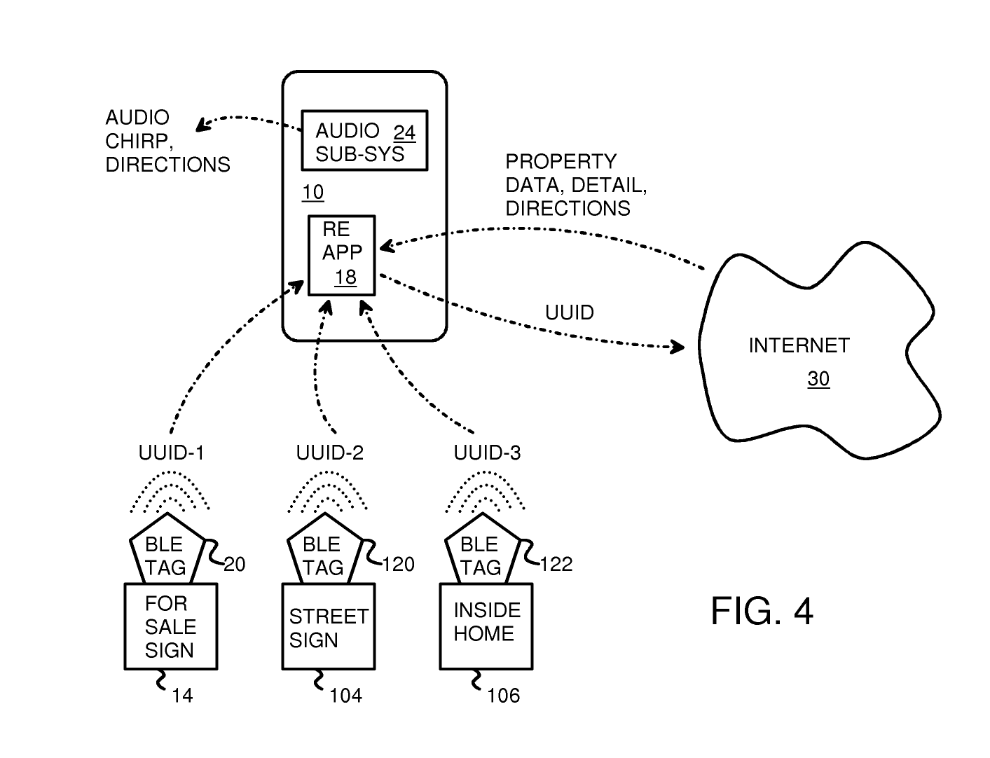

FIG. 4 shows a real estate app running on a mobile device receiving broadcasts from chirp beacons on real estate signs. The user of mobile device 10 is a prospective buyer and launches real estate app 18, which is running on mobile device 10. As the prospective buyer drives by an intersection with real estate street sign 104, chirp beacon 120 broadcasts its UUID-2, which is received by a Bluetooth receiver on mobile device 10, decoded, and sent to real estate app 18. Real estate app 18 sends UUID-2 over Internet 30 to a backend serer that looks up UUID-2 and returns property information which may include driving directions to direct the prospective buyer to the property's address. Audio sub-system 24 may generate an audible signal such as a chirp to let the user know that the property data or directions are available.

The user may follow the driving directions provided on mobile device 10. Upon reaching the destination property, when mobile device 10 is within range of chirp beacon 20 on for sale sign 14, UUID-1 is received from chirp beacon 20. UUID-1 is sent over Internet 30 and additional property data may be received. The prospective buyer may decide to get out of the car and tour the property. Once inside, another chirp beacon 122 on interior display sign 106 (or hidden somewhere inside the home, such as placed on a fireplace mantle) broadcasts its UUID-3. Real estate app 18 can send this UUID-3 over Internet 30 to receive more localized data, such as features of the current room inside the property, or a promotional or home tour video.

Chirp beacons 20, 120, 122 may be a Bluetooth Low-Energy (BLE) tag, iBeacon, or similar broadcast device. The broadcast range may vary, such as being limited to a few meters for inside home chirp beacon 122 but wider for external chirp beacons 20, 120. Additional signs and chirp beacons may be used, such as for several major intersections and along the routes to the property, and in several of the rooms within the home for sale.

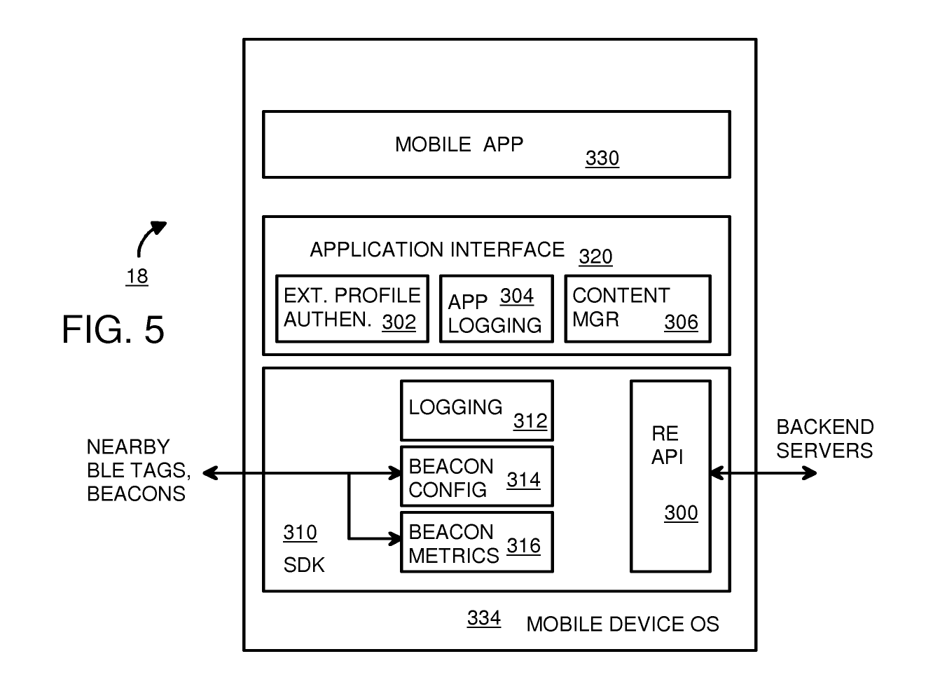

FIG. 5 is a more detailed block diagram of a mobile device running a real estate app that receives broadcasts from chirp beacons. Real estate app 18 includes high-level mobile app 330 and lower-level components in application interface 320 and in Software Developer Kit (SDK) 310. Low-level functions in SDK 310 include beacon configuration 314 which sends packets to a nearby chirp beacon to configure that chirp beacon, such as to program its UUID or major or minor addresses, period of time between broadcasts, broadcast power (range), etc. SDK 310 accesses functions or routines in mobile device OS 334 that take the desired values for UUID, etc., format them, and transmit them through the physical RF circuits of mobile device 10. Some functions, such as to configure chirp beacons, may be enabled or present only for selling agent users, not for prospective buyer users.

When a broadcast from a nearby chirp beacon is received by the low-level RF hardware on mobile device 10, functions in mobile device OS 334 strip off prefixes and headers and extract data such as the UUID, which is passed on to beacon metrics 316. The time stamp may also be stored with the UUID by logging function 312. Real Estate API 300 can then send the UUID over the Internet to the backend server and in response receive property data that is sent up to content manager 306. Content manager 306 can send the property data content to mobile app 330 for display to the user, or to a mapping app for directions. When the term UUID is used, it is understood that the major and minor address values may also be included with the base UUID. The UUID by itself indicates which mobile app the OS should wake up. All 3 parameters, UUID, Major, and Minor are used by that app to uniquely identify the property.

The property may be logged by app logging function 304 in application interface 320. This allows the user to view data from several most-recently visited properties. When the user first logs on using mobile app 330, external profile authentification module 302 verifies the user name and password using an external authentification server on Internet 30. Application interface 320 thus provides mid-level functions and modules to higher-level mobile app 330. Mobile app 330 may define locations on the display screen to display the property data and formatting information such as fonts and colors, while lower-level functions retrieve and draw the data to the display screen. Many other modules and functions may be used, such as various standard routines or library functions and routines.

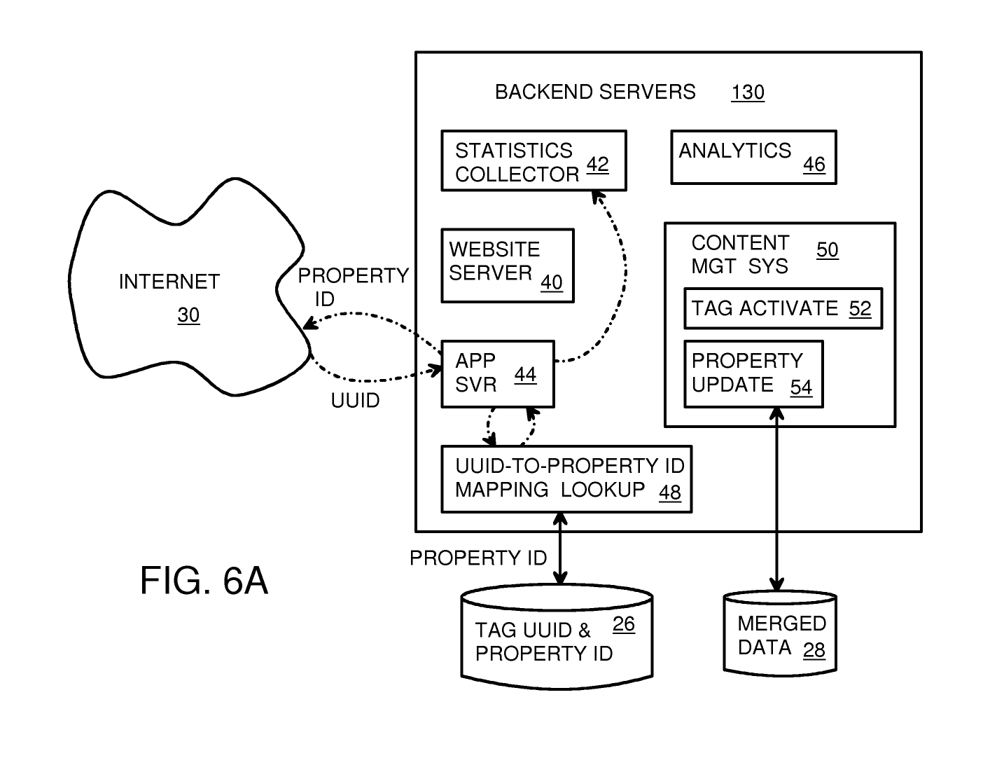

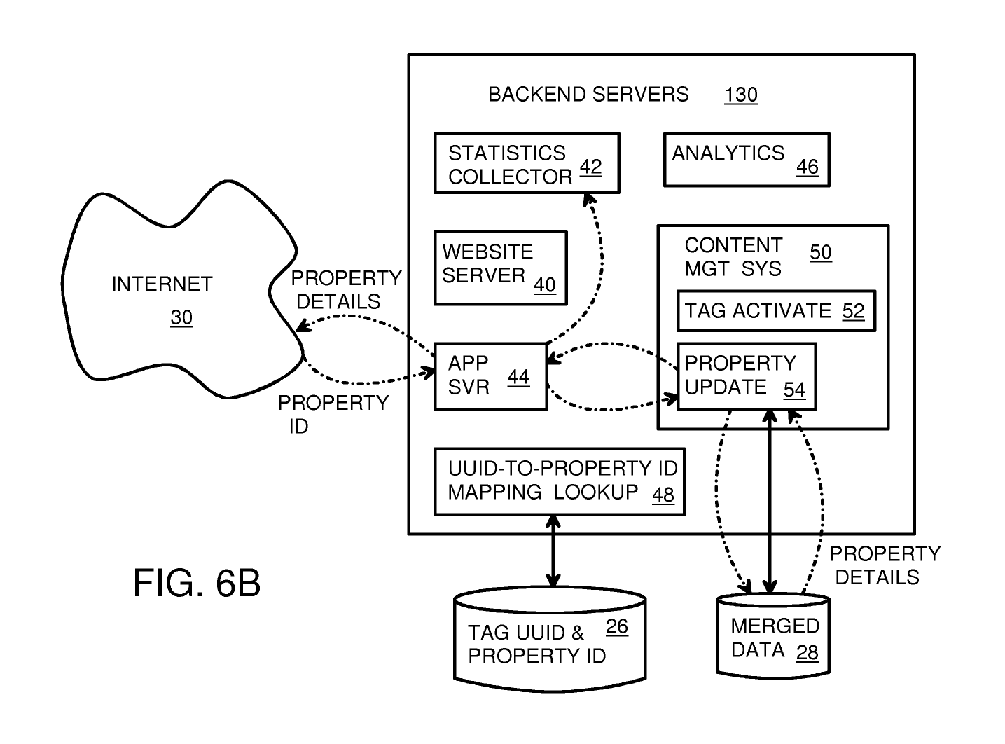

FIGS. 6A-B show backend servers looking up a UUID and providing property details. A two-step lookup is used. First the UUID is looked up to obtain a property ID (FIG. 6A), then this property ID is looked up to fetch the property details (FIG. 6B). While a single lookup could be used, two steps allows the chirp beacon UUID's to be independent of the property. This independence allows the selling agent to move real estate signs to other properties and simply re-assign UUID's to different property ID's. For example, street signs at busy intersections may advertise different open houses on different weekends. The selling agent simply re-assigns the sign's UUID to a different property ID for each weekend's open house.

In FIG. 6A, when a real estate app 18 (FIG. 5) on a mobile device sends a UUID lookup request, the request is received by app server 44 on backend servers 130. App server 44 extracts the UUID and send the UUID to UUID mapper 48, which looks up the UUID in UUID and property ID database 26. The property ID that matches the UUID is returned to app server 44 and sent back over Internet 30 to the real estate app.

Statistics collector 42 may store the UUID and/or property ID to track that the user was within range of the real estate sign identified by the UUID. Analytics 46 may later analyze the statistics and provide reports to the selling agent, such as the number of users, time and days of visits, length of stay, other properties visited, etc. When the prospective buyer adds this property as a favorite property, the selling agent could also be notified of this important information. The selling agent may also be provided with contact information for the prospective buyer that visited the property. Other data may include the number (or percentage) of prospective buyers that drove by a street sign at a busy intersection but never drove to the property, or the number (or percentage) of prospective buyers that drove to the property but did not enter the home. When a selling agent accesses such analytics information from a website rather than from real estate app 18 on a mobile device, website server 40 handles the request rather than app server 44.

In FIG, 6B, property details are provided by the backend servers. Real estate app 18 sends the property ID that was retrieved for the UUID through Internet 30 to app server 44. App server 44 sends the property ID to content management system 50, which looks up the property ID in merged database 28. The property details are returned to content management system 50 and sent back to app server 44 for return over Internet 30 to real estate app 18 on mobile device 10. Property updater 54 looks into the merged database to add or update/refresh information in the database and also accomplishes a de-duplication of property data coming from multiple aggregation sources. Statistics collector 42 can log that the user obtained the property details, and the specific details requested may be logged, such as whether the user requested driving directions or only the sales price.

When a selling agent updates property details, such as when lowering the asking price, property updater 54 over-writes the property details in merged database 28. When the selling agent adds a new property, a new property record is created by property updater 54 and stored in merged database 28. A new property ID can be generated and assigned to the new property's record.

The selling agent may assign a real estate sign to a property by using tag activator 52. The UUID for the chirp beacon that will be attached to the real-estate sign is entered by the selling agent, or read directly from the chirp beacon using a Bluetooth RF receiver, and this UUID is linked to the property ID in UUID and property ID database 26. Multiple signs may be linked to the same property ID.

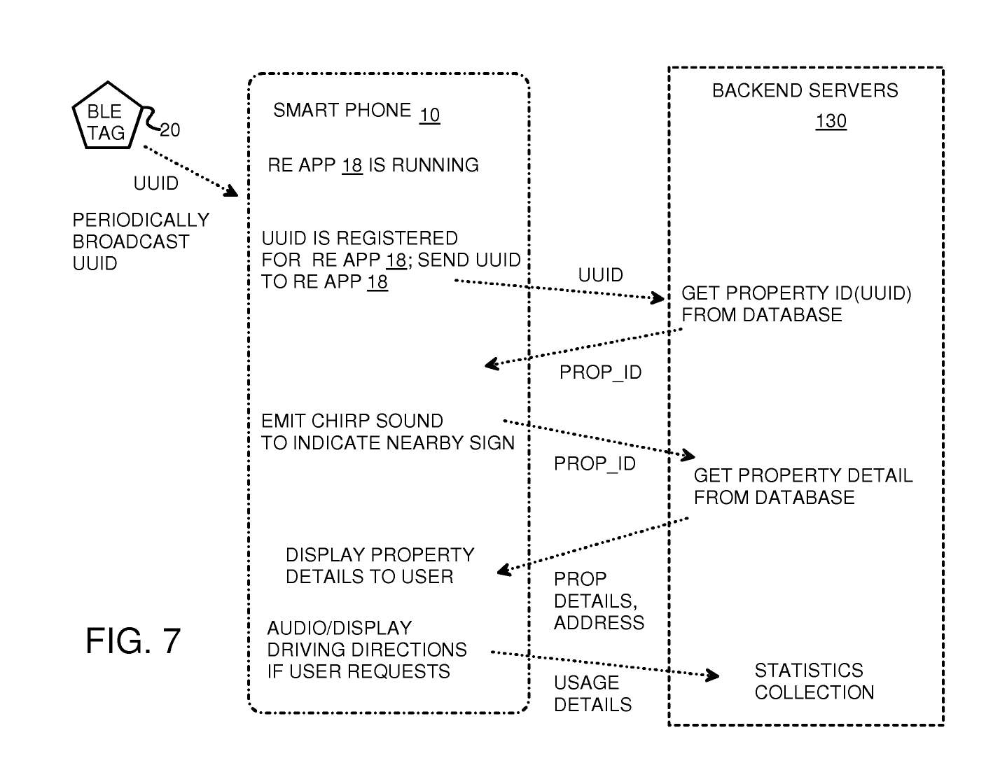

FIG. 7 is a flow diagram showing messaging between a real estate app on a mobile device and backend servers when a UUID is obtained from a chirp beacon. Chirp beacon 20 periodically broadcasts a packet that contains its UUID. Once mobile device 10 is within range of chirp beacon 20, and real estate app 18 is running, then next UUID broadcast packet received by mobile device 10 is decoded by the mobile device OS, which determines that real estate app 18 is registered for the UUID. Only a range of UUID's may be assigned to real estate app 18, or all UUID's may be sent to real estate app 18.

Real estate app 18 then send the UUID over the Internet to backend servers 130. The UUID is looked up in UUID and property ID database 26 to obtain the property ID, which is sent back to real estate app 18. The mobile device 10 may emit a chirping sound to tell the user that a property is nearby. The user may look at real estate app 18 on his device and fetch property details, or real estate app 18 may automatically fetch the property details by sending the property ID to backend servers 130. The property ID is looked up in merged database 28 and the property details are returned to real estate app 18. The property details may then be displayed to the user on mobile device 10.

The property details include the property address. The user may request driving directions by pressing a button on real estate app 18 that launches a mapping app. The mapping app is provided with the property address and can obtain the current location by GPS. Alternately, the directions themselves may be provided as part of the property details and displayed without a separate mapping app, or a mapping app may be provided within real estate app 18 or linked to within real estate app 18. The directions may include audio turn-by-turn directions, or may link to a car's navigation system through a RF link between mobile device 10 and the car.

Statistics may be collected and stored in backend servers 130. Statistics may include logged events and UUID and property ID data. The logging feature includes a timestamp that can be used to determine time duration for the visit to the property, or even the time to drive to the property, which may indicate that the user visited other properties along the way when the time duration is longer than usual. The user may pass several real estate signs with chirp beacons when driving to the property, and these may be logged as well.

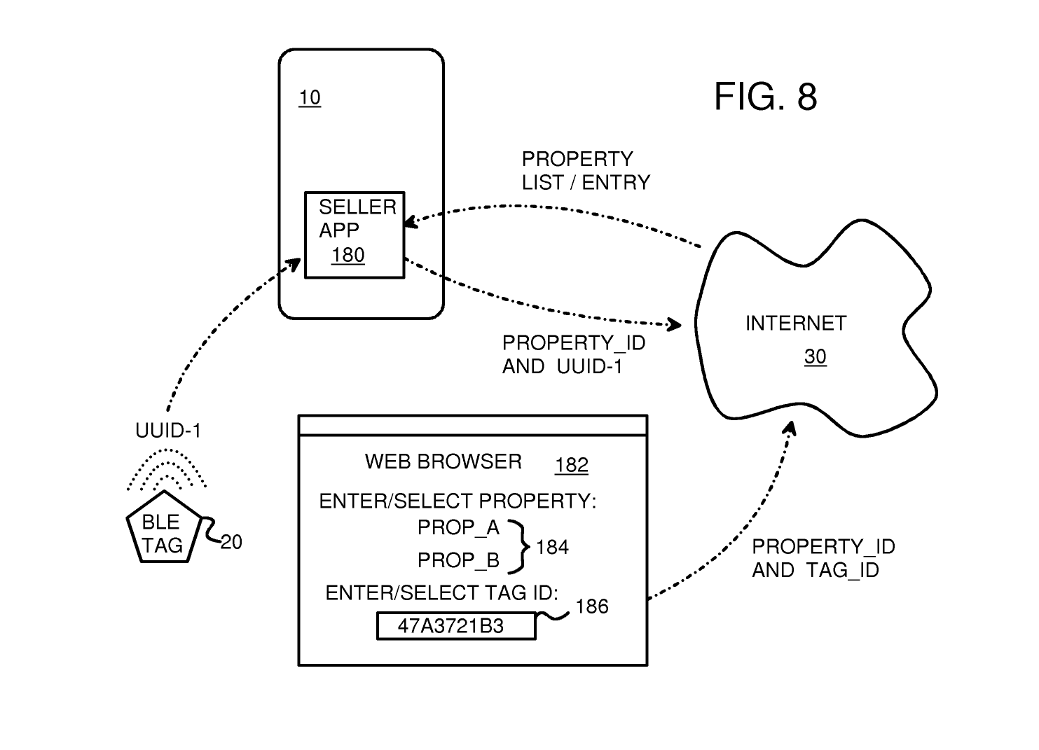

FIG. 8 shows a selling agent configuring a chirp beacon. A selling agent has mobile device 10 with an enhanced version of real estate app 18, real estate sellers' app 180. The selling agent desires to assign chirp beacon 20 to a new property. Chirp beacon 20 broadcasts its UUID, which is detected by nearby mobile device 10 and sent to real estate sellers' app 180. Real estate sellers' app 180 displays a list of properties being sold by this selling agent user, and the user selects one of these properties to assign chirp beacon 20 to. The selected property ID and the UUID read from chirp beacon 20 are sent back over Internet 30 to backend servers 130 where they are linked in UUID and property ID database 26. The user could also manually type in the UUID, major and minor values.

The selling agent may also perform this assignment using web browser 182. List 184 of properties being sold by this selling agent are displayed by web browser 182, and the user selects one of these properties to assign the chirp beacon to. The selling agent can read the UUID or other tag identifier that is printed on the back of chirp beacon 20 and enter this UUID into text box 186. Alternately, a Bluetooth reader attached to the computer that web browser 182 is running on can detect the UUID broadcast from chirp beacon 20 and display it in text box 186, or display a list of nearby chirp beacons. The UUID entered or detected and the selected property's property ID are sent back over Internet 30 to backend servers 130 for linking in UUID and property ID database 26.

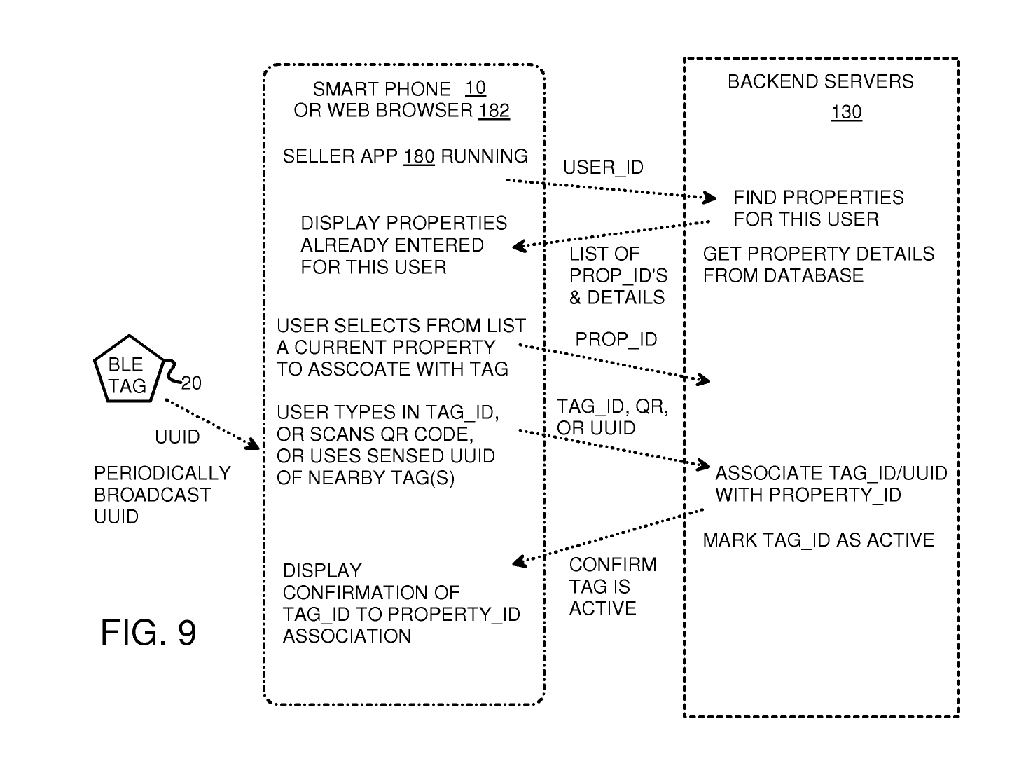

FIG. 9 is a flow diagram showing messaging when a selling agent links a chirp beacon to a property. A selling agent has mobile device 10 running real estate sellers' app 180, or uses web browser 182. The seller logs on and his user ID and password are verified by backend servers. A list of properties being sold by this user is fetched from backend servers 130 and displayed to the user. Some property details such as address may also be displayed on mobile device 10 or on web browser 182. The user selects one of these properties to assign chirp beacon 20 to. The corresponding property ID is sent to backend servers 130, either immediately after selection or once the UUID is obtained.

Chirp beacon 20 broadcasts its UUID, which is detected by nearby mobile device 10 and sent to real estate sellers' app 180. The selected property ID and the UUID read from chirp beacon 20 are sent back over Internet 30 to backend servers 130 where they are linked in UUID and property ID database 26.

Alternately, the user types in the UUID or other identifier on the back of chirp beacon 20. A Q-R code printed on chirp beacon 20 may also be scanned, decoded, and sent to obtain the UUID. An intermediate lookup server may be used to convert the Q-R code or other identifier on chirp beacon 20 to the UUID.

The tag, chirp beacon 20, is marked as active in backend servers 130, perhaps after confirmation with the user. The confirmation is sent from backend servers 130 to real estate sellers' app 180 or web browser 182 and displayed to the user.

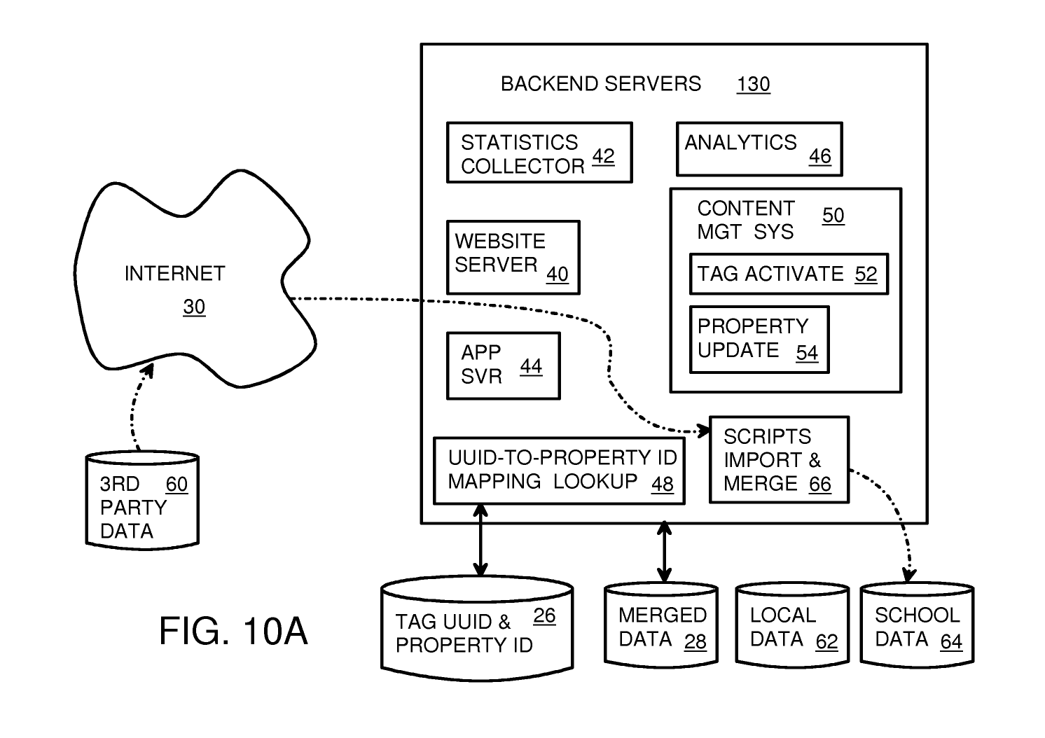

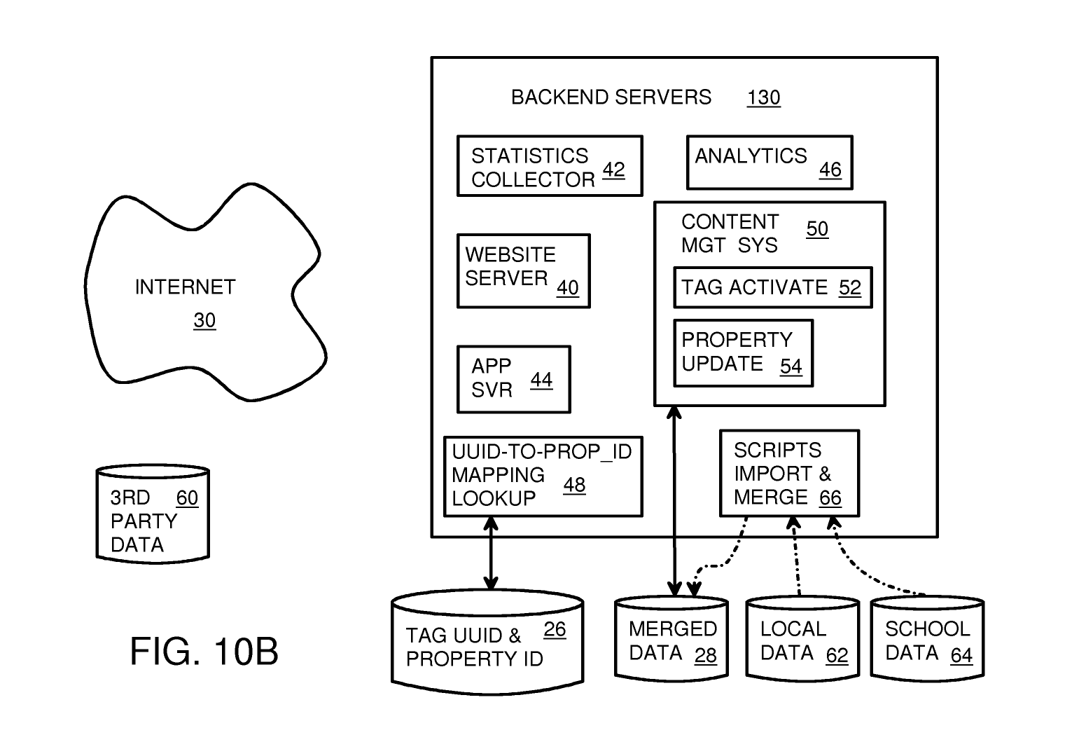

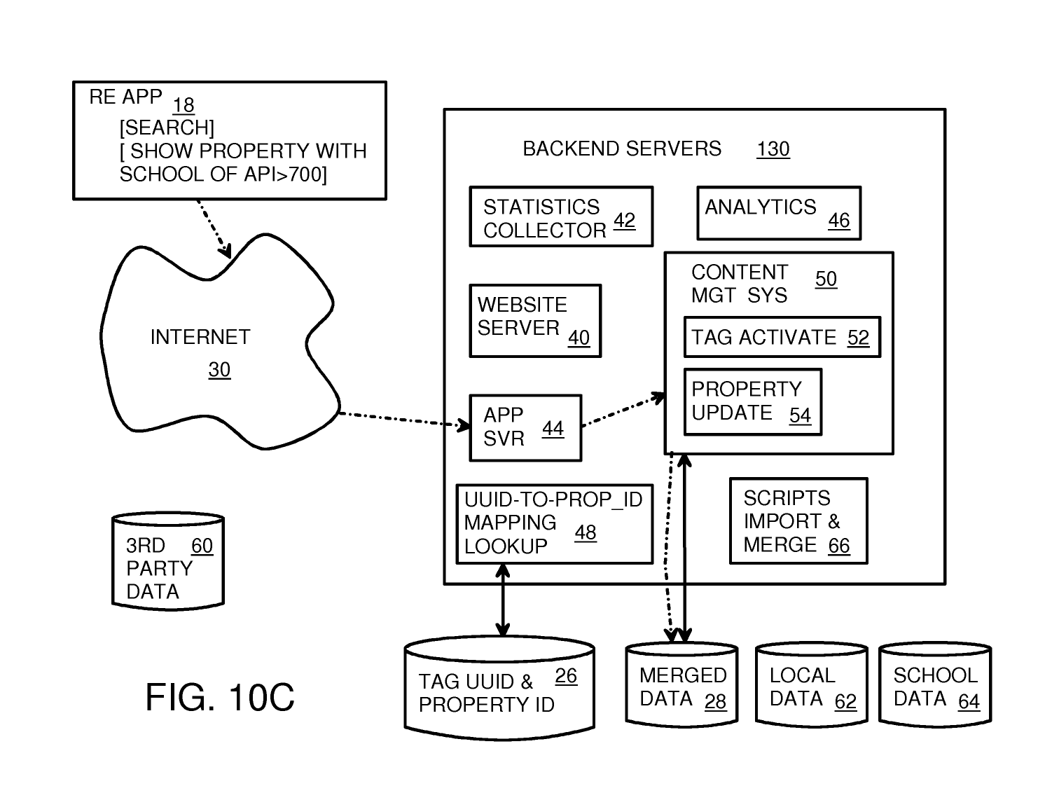

FIG. 10A-C show merging data from external sources for retrieval by a real estate app. In FIG. 10A, 3^{rd} party data is read from an external source. Third party data 60 is read from Internet 30 by importing engine 66 in backend servers 130. One particular type of third party data 60 that is useful for real estate app 18 is school rating data. Importing engine 66 writes data from third party data 60 as school data 64. Scripts may be executed by importing engine 66 for complex merging operations.

In FIG. 10B, the third-party school data is merged with local data to generate merged data. Importing engine 66 reads records from school data 64 for property addresses in local data 62 to create merged records that are written to merged database 28. School rating data is very useful to prospective buyers of real estate. The ratings for elementary, middle, and high schools may be stored for each property address in merged database 28, allowing faster access by prospective buyers. School information for all properties is mapped in a two-way association. A user can query ‘show me all the properties for sale with good schools’; such a question cannot be asked from known existing real-estate apps.

In FIG. 10C, a prospective buyer using real estate app 18 performs a search for properties with school ratings of 700 or better. The user may specify other search parameters such as house size, price, and city. The user's search generated by real estate app 18 is sent through Internet 30 to app server 44 in backend servers 130. App server 44 uses content management system 50 to search for properties that match the search parameters. Since school ratings are included in the merged records of merged database 28, a single database may be searched for matching records. A search across several databases would likely be slower. The records from merged database 28 that match the search parameters are listed and sent back to real estate app 18 for display to the user. A limit to the number of matched records to display may be imposed, and the total number of matching records may be displayed with suggestions to further refine the search.

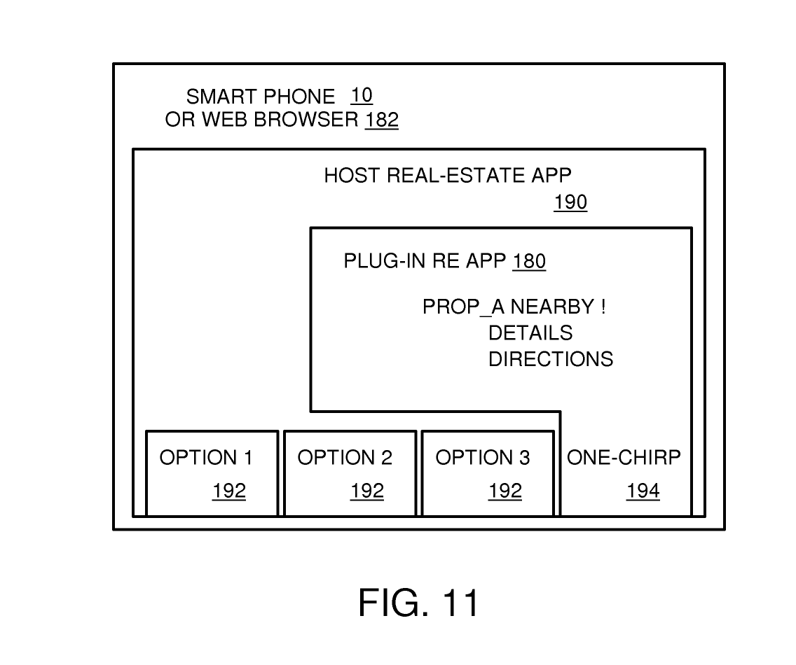

FIG. 11 shows the real estate app as a plug-in app to a larger real estate application on a mobile device. Real estate app 18 may be a modular application available to other developers as a Software Developer Kit (SDK) or other embedded function. For example, host real estate app 190 running on mobile device 10 or in web browser 182 may display its own data to users. Option tabs 192 may be displayed within host real estate app 190 that allow users to perform various functions or access various features. Real estate app 18 or real estate sellers' app 180 may appear within host real estate app 190 when the user presses, clicks on, or otherwise selects option tab 194. Then real estate app 18 or real estate sellers' app 180 displays within a sub-window within host real estate app 190. Data may be shared among real estate sellers' app 180 and host real estate app 190, such as property addresses, asking prices, and other property data. Thus real estate app 18 or real estate sellers' app 180 may be integrated within a larger real estate application such as Zillow, Trulia, ziprealty, redfin, MLSlistings, HomeSnap, and broker software such as KellerWilliams, Century21, Coldwell banker.

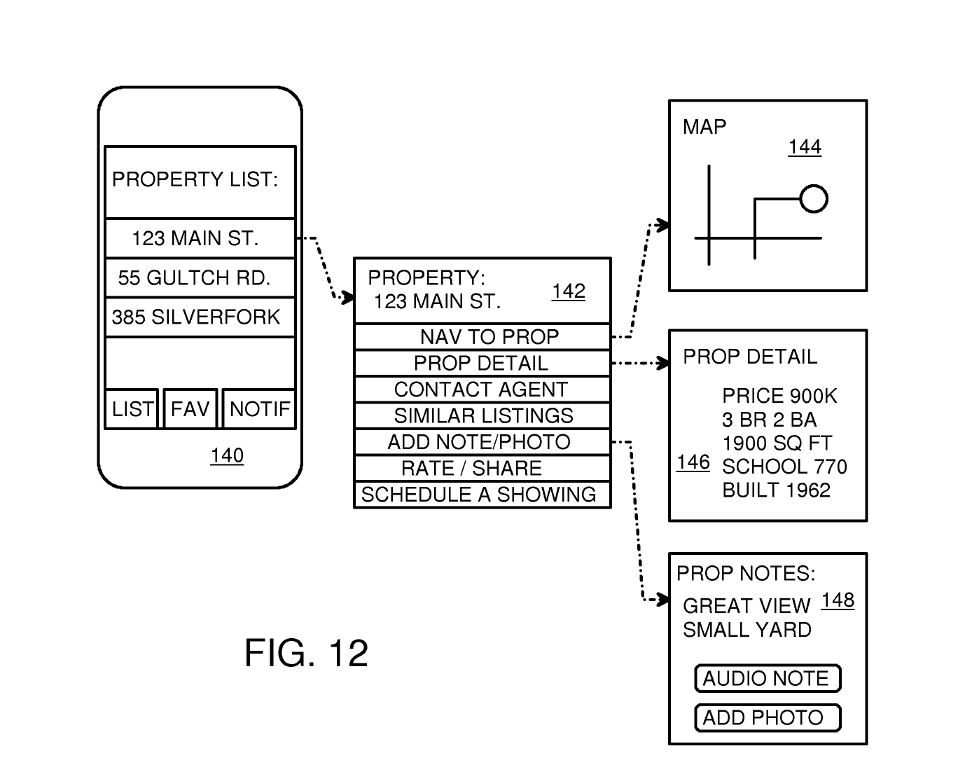

FIG. 12 shows property details being displayed on a mobile device using menus on a real estate app. Mobile device 140 has a display screen that is displaying content generated by real estate app 18. A list of properties is being displayed. This list of properties may be nearby properties, recently visited properties, favorite properties, the results of a search, or a list from a buyer's agent. The user selects one of the listed properties such as by tapping on the property's address being displayed. Then sub-menu 142 is displayed on mobile device 140. Sub-menu 142 shows the selected property's address, and has menu selections for directions to the property, to show property details, to contact the selling agent, to search for similar listings, to add a note or a photo for this property, to rate this property or share it with another person, and to schedule a showing. Other sub-menu items may be present, and not all of these sub-menu items may be present on all displays.

When the user selects the navigate to property sub-menu item, map 144 is displayed on mobile device 140. Audible directions may also be played to the user, prompting the user with turn-by-turn directions. Map 144 shows the location of the selected property and may also show the user's current location and a route to the selected property.

When the user selects the property details sub-menu item or button, property detail page 146 is displayed on mobile device 140. Property details such as asking price, number of bedrooms, bathrooms, square footage, school ratings, year constructed, and other details may be displayed. More specific details such as a history of changes of asking price may be displayed by selecting a “More” button (not shown) on detail page 146. The details shown on details page 146 may vary depending on real estate app 18 and the size of the display screen of mobile device 140.

When the user selects the add note/photo sub-menu item, property notes page 148 is displayed on mobile device 140. The user may type in personal notes about the property, such as an assessment of the condition of the property, views, or other features that are of interest to the prospective buyer. The prospective buyer may speak to capture the notes after pressing the Audio Note button to begin an audio recording. When the user presses the Add Photo button, the camera on mobile device 140 is activated to take a picture of the property, and this picture is stored and linked to for this user's account for the selected property.

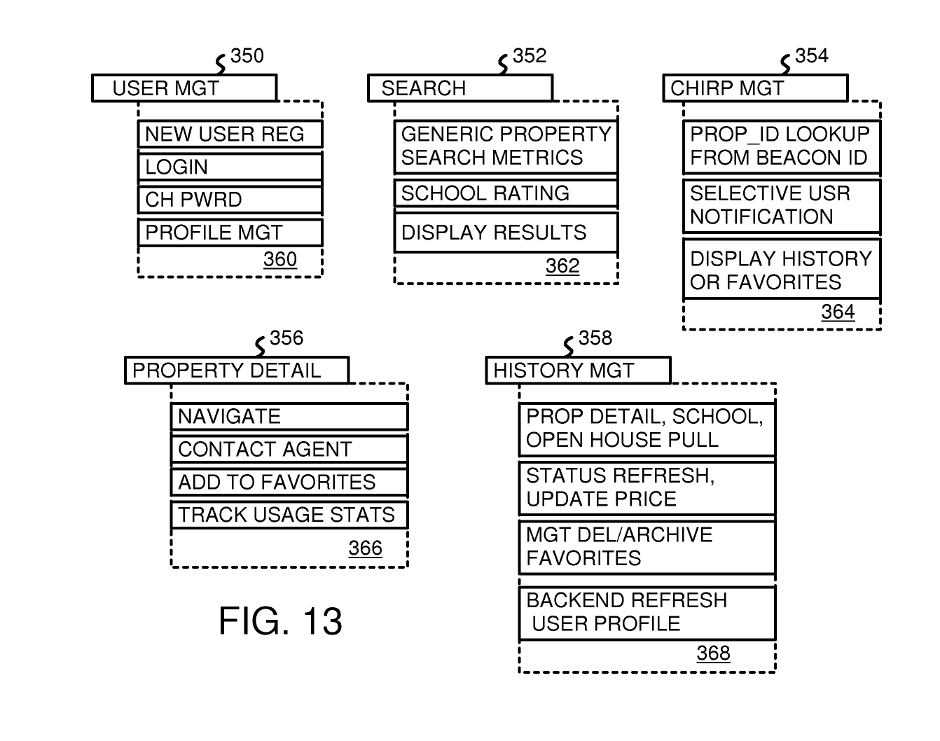

FIG. 13 shows menu items displayed on a web browser for a selling agent user. Selling agents are more sophisticated users of real estate app 18 since they perform more functions such as configuring chirp beacons and maintaining property records. While FIG. 13 shows menus for a web browser 182 that accesses backend servers 130 through website server 40, some of all of these menus could be displayed on mobile device 10 using real estate sellers' app 180.

When the user selects user management menu button 350, user management menu 360 is displayed. Menu 360 allows the user to register a new user, login, change the password, or change the account profile and settings.

When the user selects search menu button 352, user search menu 362 is displayed. Menu 362 allows the user to specify search parameters, such as generic metrics such as price, location, and size. School rating may also be specified as a search parameter. The results may be displayed using the display sub-menu selection, or by other means.

When the user selects chirp beacon management menu button 354, chirp beacon management menu 364 is displayed. Menu 364 allows chirp beacons 20, 120 to be configured. The UUID of a nearby chirp beacon can be linked to a selected property, or the UUID may be typed in. The backend servers can be configured to notify the user or selling agent when another user is within range of a chirp beacon. A history of chirp beacons in use, or for favorite chirp beacons may also be displayed through menu 364.

When the user selects property detail menu button 356, property detail menu 366 is displayed. Menu 366 allows the user to obtain driving directions, contact the selling agent, add the selected property to a favorites list, or track usage statistics. Additional sub-menus may be activated for analytics.

When the user selects history management menu button 358, history management menu 368 is displayed. Menu 368 allows the selling agent to enter a new property, add or edit property details, see property details and school ratings, update the asking price, post a video, or to delete or archive a property or a favorite property. Backend refresh updates values for information in history buffers and favorites, including prices.

Other menu items may be present, or further levels of nested menus many be displayed. Some menu items may be hidden or grayed out, such as seller functions when a buyer is using the app.

### Alternate Embodiments

Several other embodiments are contemplated by the inventors. For example a variety of property information could be provided, such as sales price, history of price changes, days on the market, water, utility, tax, and school districts, school ratings, liens, lawsuits, permits, or other records concerning the property, room sizes, views, photographs and videos and virtual tours of the property, social network posts about the property or neighborhood, times and dates of open house showings, other listing by the selling agent, days on market, estimated monthly mortgage payment, sales prices and closing dates of similar homes, etc. The contact information for prospective buyer 12 could be kept secret from the selling agent while aggregate usage statistics are sent to the selling agent. Prospective buyer 12 could be provided the option to contact the selling agent or remain anonymous.

Various caching and logging schemes may be used. Links to property data on a backend server may be stored on mobile device 10, or key data such as price, address, number of rooms, etc. may be cached on mobile device 10 while more lengthy property details may be linked to. The details and number of properties cached may vary with memory availability on mobile device 10 or configuration settings. For example UUID database 22 searches for a matching UUID, major, and minor values and provides a property_ID. The mobile app looks up the property_ID in a local cache on mobile device 10 to determine if real estate app 18 has already seen that property. When real estate app 18 has already cached the property ID, real estate app 18 updates its last seen timer and does not chirp. If the property_ID is new real estate app 18 does another lookup over the Internet to the property database and pulls the respective property info. If the app user has customized his experience, the app will do another lookup in a preferences database to find out if the user is asking to be notified via a chirp or not. The property is tracked by the app until the user reviews the listings and marks the property as a favorite or deletes it.

Commercially available routines and functions may be initially used for faster time-to-market purposes, and later replaced with custom designed routines and functions to improve performance of real estate app 18. Real estate app 18 may be a stand-along app or may be complied into another larger real estate app or other kind of application. Various partitionings of functions, routines, modules, libraries, objects, and components are possible. Functions and processes can be programmed and executed by a CPU or other processor, or can be implemented in dedicated hardware, firmware, software, or in some combination. Beacon tags can be customized with special antennas and higher-power front end amplifiers such that their power and range allows for longer ranges of detection so that a property can be advertised even further than the 100 meter typical distance, such as 500 meters.

While a mobile device such as a smart phone has been described, other kinds of mobile devices could be substituted, such as smart watches, wearable computers, tablets, automobile computers and networked devices, other smart communication devices. Protocols may be enhanced. Functions may be implemented on different layers of software than described earlier. Messages passed between mobile device 10 and backend servers 130 may be combined or further divided, and additional messages may be used.

While a two-step lookup has been shown, first the UUID is looked up in UUID and property ID database 26 to obtain the property ID, and then the property ID is looked up in merged database 28 to obtain the property data, more or fewer lookups could be performed. Additional database may be consulted for some of the information. Rather than have real estate app 18 first send the UUID and then send the property ID, real estate app 18 could send the UUID and directly receive property data without having to send the property ID. Various combinations and formats of data, records, and databases could be used. The UUID could be fixed or could be programmable in the chirp beacon 20, or only the major and minor addresses could be programmable but not the base UUID. While the term UUID has been described, the UUID is considered to include the major and minor values. For example, the UUID, major, and minor values could be combined and sent as a beacon identifier for lookup. The UUID could be or include a universal-resource-locater (URL), Internet Protocol (IP) address, or other unique identifier.

The Chirp Beacon posted on a sign at an Intersection may wake up the app with that property information, but data for other properties for sale in that area could also be sent to the mobile app. Thus properties that are not mapped to a beacon can be displayed. When a user browses those properties, the app can keep track. So the chirp beacon is used to wake up the app, and provide context. The app can retrieve other properties. This method of invocation of the app leads users of the app to get additional property information, and the sales agent obtains statistics on which other properties are significant competition. Using the geo-location capability of the app, the statistics of non-chirp enabled properties can also be tracked and reported back to the selling agent.

While for simplicity a real estate property for sale has been described, other real estate activities could benefit. Rather than sell a property, the property could be available for lease or rent. The property could be residential, commercial, or industrial, single-family or multi-unit. Other kinds of property or items for sale, rent, lending, or donation could also be substituted, such as automobiles.

In some embodiments, a real estate sign may be used for more than one property. The data returned back to the mobile app can include multiple property_IDs. There is no restriction that there is a one-to-one mapping of UUID to Property_ID. E.g. Property ID can be an array of Property_ID's. A composite property ID for a group of properties may be used, such as for all condos sold by the selling agent in a common building. Once inside the building, a local sign with a local chirp beacon may have a UUID linked to just one property. One beacon could be used for multiple properties in a neighborhood. For new construction, there could be 10 model homes to choose from and all 10 would show up as different options.

A single beacon at an intersection could potentially map to multiple properties. For example a lamppost or traffic light at an intersection could be leased and a universal beacon placed there. This beacon could broadcast a UUID but the backend servers know the location of the beacon and return all the property_ID's for that area. A potential buyer could have his app associated to an agent using an ‘association code’. A buyer's agent gives his code to the buyer, at which point the statistics of what the buyer does is sent to his or her buyer agent.

While driving directions have been described, walking or public transit direction could be provided, especially for properties located in high density city centers.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A mobile application for automatic notification comprising:
a beacon receiver interface for receiving a beacon packet sent by a beacon that is in a proximity range of a mobile device that is running the mobile application,
wherein the beacon transmits the beacon packet at least once every second;
a beacon parser that extracts a beacon identifier from the beacon packet received by the beacon receiver interface;
a network interface for connecting to an Internet;
a first lookup interface for sending the beacon identifier over the network interface to a first backend server and receiving a property identifier from the first backend server;
a second lookup interface for sending the property identifier over the network interface to a second backend server and receiving property data from the second backend server;
an audible notifier that activates a sound sub-system in the mobile device to make an audible sound when the property data is received from the second backend server; and
a display notifier for displaying the property data received from the second backend server on a display of the mobile device,
whereby automatic notification of the property data is made when the mobile device is within the proximity range of the beacon.

2. The mobile application for automatic notification of claim 1 wherein the proximity range is at least 3 meters and less than 500 meters,
wherein the mobile device does not receive the beacon packet when the mobile device is beyond the proximity range from the beacon.

3. The mobile application for automatic notification of claim 2 wherein the beacon is a Bluetooth Low-Energy (BLE) tag or an iBeacon that is powered by a battery.

4. The mobile application for automatic notification of claim 2 wherein the beacon comprises:
a central processing unit for executing routines including a routine to transmit the beacon packet;
a RF transmitter for transmitting the beacon packet;
a timer for periodically transmitting the beacon packet at least once every second;
a battery for powering the beacon; and
a programming interface for receiving a configuration for the beacon, the configuration including the beacon identifier.

5. The mobile application for automatic notification of claim 4 wherein the beacon packet comprises:
a header;
a Media-Access-Controller (MAC) address of the beacon;
the beacon identifier that includes a UUID and major and minor address fields; and
a cyclical-redundancy-check (CRC);
wherein property information is not contained in the beacon packet.

6. The mobile application for automatic notification of claim 1 further comprising:
a selling agent interface, activated for a selling agent but not activated for prospective buyers, the selling agent interface displaying a list of properties listed by the selling agent, the selling agent interface receiving a property selection from the selling agent and receiving a new beacon identifier from the selling agent for a new beacon used by the selling agent for a new property indicated by the property selection;
a beacon-property linking interface for sending the property selection and the new beacon identifier to the network interface and to the first backend server, the first backend server returning a new property identifier for the property selection when the new beacon identifier is received,
whereby the new beacon identifier is linked to the new property identifier, the selling agent using a new beacon to automatically notify prospective buyers about the new property when a prospective buyer's mobile device is within the proximity range of the new beacon for the new property.

7. The mobile application for automatic notification of claim 6 wherein the selling agent interface receives the new beacon identifier by using the beacon receiver to read the new beacon identifier from the new beacon that is within the proximity range to the mobile device.

8. The mobile application for automatic notification of claim 6 wherein the selling agent interface receives the new beacon identifier when the selling agent types in the new beacon identifier into a text box displayed on the mobile device;
wherein the new beacon identifier is printed on a body or casing of the new beacon.

9. The mobile application for automatic notification of claim 1 wherein the mobile application is a sub-application that is executed within a composite real estate application.

10. The mobile application for automatic notification of claim 1 wherein the property data includes an address of a property identified by the property identifier;
wherein the beacon is located on a real estate intersection sign temporarily placed at a street intersection that is more than the proximity range to the property;
further comprising:
a navigation routine, activated when the property data is received, that receives a current location of the mobile device and the address of the property, the navigation routine providing directions from the current location to the address of the property using the sound sub-system of the mobile device,
whereby directions from the real estate intersection sign to the property are provided by the mobile application when the mobile device is within the proximity range of the real estate intersection sign having the beacon.

11. A real estate notification system comprising:
an app server that receives beacon identifiers from real estate apps running on mobile devices, the beacon identifiers extracted from beacon packets periodically broadcast from beacons that have a range of less than 100 meters;
a beacon mapper that receives the beacon identifiers that identify beacons and returns property identifiers for properties corresponding to the beacons;
a property database that stores property data that are retrieved using the property identifiers, the property data for a property including a street address, a selling price, and a room count for the property;
a content manager that returns the property data from the property database to the mobile devices in response to the property identifiers;
a statistics collector that logs a time and date when a beacon identifier is received from a mobile device; and
an analytics module that reads logs generated by the statistics collector to generate a seller's report, the seller's report providing a number of mobile devices that received the beacon identifier from each beacon controlled by a seller,
whereby the property data is pushed to the mobile device when the mobile device is within range of a beacon and able to receive the beacon packet.

12. The real estate notification system of claim 11 wherein the seller's report also reports a length of time that the mobile device received the beacon identifiers, wherein longer lengths of time in proximity to a beacon located at the property indicate greater interest by a prospective buyer.

13. The real estate notification system of claim 11 further comprising:
a school rating database that has ratings for schools;
an importing engine that reads data from the school rating database and writes school ratings to the property database;
wherein the property data further includes school ratings for schools assigned for children living in the property,
wherein school ratings are returned through the app server with the property data for display on the mobile device.

14. The real estate notification system of claim 11 further comprising:
a beacon activator, receiving a selected property identifier for a selected property from a selling agent, the beacon activator also receiving a new beacon identifier for a new beacon to be activated, the beacon activator writing the selected property identifier and the new beacon identifier to an entry in the beacon mapper to link the selected property to the new beacon.

15. The real estate notification system of claim 11 further comprising:
a first real estate sign on a target property;
a first beacon mounted to the first real estate sign, the first beacon periodically transmitting a first beacon packet containing a first beacon identifier;
a second real estate sign placed at a street intersection away from the target property;
a second beacon mounted to the second real estate sign, the second beacon periodically transmitting a second beacon packet containing a second beacon identifier;
wherein the property data sent to the mobile device includes a street address of the target property when the second beacon identifier is received;
wherein a mapping app is activated on the mobile device when the street address is received by the mobile device and the mobile device is not yet at the target property, wherein the mapping app provides directions from the second real estate sign to the target property,
whereby a prospective buyer is navigated from the street intersection with the second real estate sign to the target property in response to receiving the second beacon identifier.

16. The real estate notification system of claim 15 further comprising:
a third beacon located inside the target property, the third beacon periodically transmitting a third beacon packet containing a third beacon identifier;
wherein the statistics collector logs when the first, second, or third beacon identifiers are received to indicate a number of prospective buyers that have been near each beacon.

17. The real estate notification system of claim 15 wherein the statistics collector further provides immediate notification to a selling agent when the first beacon or the second beacon is received by the statistics collector,
whereby the selling agent is notified when a prospective buyer is near the first or second real estate sign.

18. A beacon notification system comprising:
a beacon that periodically broadcasts a beacon packet having a beacon identifier;
a real estate app on a mobile device, the real estate app sending the beacon identifier to a remote server when the mobile device is within range of the beacon and receives the beacon packet;
a remote mapper, coupled to the remote server, for providing a property identifier in response to the beacon identifier, wherein the beacon is for advertising a property identified by the property identifier;
a statistics collector that logs and timestamps when the remote mapper receives the beacon identifier to generate an activity log that includes beacon identifiers and timestamps and an identifier of the mobile device sending the beacon identifier; and
a content management system that retrieves property data in response to the property identifier, the property data sent back to the mobile device for display by the real estate app to a prospective buyer.

19. The beacon notification system of claim 18 further comprising:
a first requestor, in the real estate app on the mobile device, for sending the beacon identifier to the remote server;
wherein the property identifier is returned to the mobile device in response to the beacon identifier;
a second requestor, in the real estate app on the mobile device, for sending the property identifier to the content management system;
wherein the real estate app on the mobile device sends the property identifier to the content management system after the property identifier is received by the mobile device;
whereby the beacon identifier and the property identifier are looked up in separate requests from the real estate app on the mobile device.

20. The beacon notification system of claim 18 further comprising:
an intersection beacon that periodically broadcasts an intersection beacon packet having an intersection beacon identifier, wherein the intersection beacon is located on a sign at a street intersection away from the property identified by the property identifier;
wherein the real estate app activates driving directions from the street intersection to the property when property data is retrieved using the intersection beacon identifier received from the intersection beacon;
wherein a prospective buyer is provided directions to the property from the street intersection with the intersection beacon.
